(19) United States
(12) Patent Application Publication
(10) Pub. No.: US 2011/0221894 A1
(43) Pub. Date: Sep. 15, 2011

(54) IMAGE MEASURING APPARATUS

(75) Inventors: Masaki KURIHARA, Yokohama (JP); Shinichi UENO, Osaka (JP)

(73) Assignee: MITUTOYO CORPORATION, Kanagawa (JP)

(21) Appl. No.: 13/024,598

(22) Filed: Feb. 10, 2011

(30) Foreign Application Priority Data
Mar. 11, 2010 (JP) 2010-054038

(51) Int. Cl. H04N 7/18

(52) U.S. Cl. 348/142; 348/E07.085

(57) ABSTRACT

An image measuring apparatus includes an image capturing controller, a location obtainer, a combined-image generator, an error calculator, an image measurer, and a corrector. The image capturing controller causes relative movements between a measured object and an image capturer. The location obtainer acquires a location at which the image capturer captures an image of the measured object. The combined-image generator forms a combined image by superposing the images captured by the image capturing controller. The error calculator calculates, for each of combining sections, an error that occurs at a combining section when the combined image is formed, based on the location acquired by the location obtainer. The image measurer measures the measured object, based on the number of pixels in the combined image. The corrector corrects measurement results of the image measurer, based on the error for each of the combining sections calculated by the error calculator.

### CROSS-REFERENCE TO RELATED APPLICATIONS

The present application claims priority under 35 U.S.C. §119 of Japanese Application No. 2010-054038, filed on Mar. 11, 2010, the disclosure of which is expressly incorporated by reference herein in its entirety.

### BACKGROUND OF THE INVENTION

1. Field of the Invention

The present invention relates to an image measuring apparatus.

2. Description of Related Art

Conventionally, an image measuring apparatus is known to have an image capturer capturing an image of a measured object, a movement mechanism causing a relative movement between the measured object and the image capturer, and a controller controlling the image capturer and the movement mechanism, in which the measured object is measured based on an image captured by the image capturer (for example, Japanese Patent Laid-Open Publication No. 2000-346638). A three-dimensional measuring apparatus (an image measuring apparatus) with image measuring capability, described in Japanese Patent Laid-Open Publication No. 2000-346638, has a CCD (Charge Coupled Device) camera (an image capturer), a movement mechanism causing a relative three-dimensional movement between a measured object and the CCD camera, and a computer (a controller).

Such an image measuring apparatus allows a shape and dimensions of a measured object by processing an image captured by the image capturer. Specifically, a distance corresponding to one pixel in an image captured by the image capturer is known. Therefore, for example, based on a number of pixels between edges of a measured object, a dimension of the measured object can be measured. However, there is a circumstance that, when measuring a measured object that is larger than a field of view of the image capturer, the measured object extends beyond the borders of an image captured by the image capturer, and therefore, the measured object cannot be adequately measured.

FIGS. 6(A)-6(C) illustrate examples of measuring a circle 110, which is larger than a field of view of an image capturer. To measure a pattern 100, which includes the circle 110 as a measured object that is larger than fields of view R1-R4 of the image capturer, for example, as illustrated in FIG. 6(A), a controller directs a movement mechanism to cause relative movements between the circle 110 and the image capturer, and directs the image capturer to capture images of 4 sites on a circumference of the circle 110. And, edge detection is performed with respect to the 4 images captured by the image capturer, and thereby, a center, a diameter, and the like, of the circle 110 are measured.

Here, to reduce a load of image processing, the edge detection is not performed with respect to the entirety of the images captured by the image capturer, but is performed with respect to insides of arc-shaped mask patterns M1-M4 of the images captured by the image capturer. The mask patterns M1-M4 are specified according to the shape of the measured object within the images captured by the image capturer. Therefore, there is a circumstance that, when a location of the circle 110 is out of alignment with a predetermined location (see FIG. 6(B)), or when a dimension of the circle 110 is larger than a predetermined dimension (see FIG. 6(C)), the edge of the circle 110 cannot be adequately detected, and thus, the circle 110 cannot be adequately measured.

With respect to this circumstance, in the three-dimensional measuring apparatus described in Japanese Patent Laid-Open Publication No. 2000-346638, the computer directs the movement mechanism to cause relative movements between a measured object and the CCD camera, and directs the CCD camera to capture a plurality of images. The images captured by the CCD camera are combined to form a combined image. With this arrangement, edge detection can be performed with respect to the combined image. Therefore, for example, when measuring the aforementioned circle 110, a ring-shaped mask pattern, which is specified according to the shape of the measured object in the combined image, can be used, and the edge of the circle 110 can be adequately detected as compared to the case of using the arc-shaped mask patterns M1-M4.

However, in the three-dimensional measuring apparatus described in Japanese Patent Laid-Open Publication No. 2000-346638, the computer directs the CCD camera to capture each image so as to avoid superposing between images. Therefore, there is a phenomenon that, due to a quantization error and the like of the image capturer, a gap may occur at a combining section when a combined image is formed, so that the center, the diameter, and the like, of the circle 110 may not be adequately measured even when the edge of the circle 110 is adequately detected.

### SUMMARY OF THE INVENTION

A non-limiting aspect of the present invention is to provide an image measuring apparatus that allows a measured object to be adequately measured even for the case where a measured object larger than a field of view of an image capturer is measured.

An image measuring apparatus in a non-limiting aspect of the present invention includes an image capturer capturing an image of a measured object; a movement mechanism (also referred to as a mover) causing a relative movement between the measured object and the image capturer; and a controller controlling the image capturer and the movement mechanism. The image measuring apparatus measures the measured object based on an image captured by the image capturer. The controller includes an image capturing controller directing the movement mechanism to cause relative movements between the measured object and the image capturer, and directing the image capturer to capture a plurality of images; a location obtainer acquiring a location at which the image capturer captures an image of the measured object; a combined-image generator forming a combined image by superposing each of the images captured by the image capturing controller to combine the images; an error calculator calculating, for each of combining sections, an error that occurs at a combining section when the combined image is formed, based on the location acquired by the location obtainer; an image measurer measuring the measured object, based on the number of pixels in the combined image; and a corrector correcting measurement results of the image measurer, based on the error for each of the combining sections calculated by the error calculator.

According to such a configuration, the controller includes the combined-image generator forming a combined image by superposing each of the images captured by the image capturing controller to combine the images. Therefore, it is possible to avoid a situation where, due to a quantization error and the like of the image capturer, a gap occurs at a combining section when a combined image is formed. However, when forming a combined image by superposing each of the images to combine the images, there is a phenomenon that, due to a quantization error and the like of the image capturer, it is possible for an error of less than one pixel to occur at a combining section in the combined image.

According to a non-limiting aspect of the present invention, the controller includes the error calculator calculating, for each of combining sections, an error that occurs at a combining section when a combined image is formed, based on the location at which the image capturer captures an image of the measured object. Therefore, the error that occurs at a combining section when a combined image is formed, due to a quantization error and the like of the image capturer, can be calculated. And, the corrector corrects measurement results of the image measurer, based on the error for each of the combining sections calculated by the error calculator. Therefore, the image measuring apparatus allows a measured object to be adequately measured even for the case where a measured object larger than a field of view of an image capturer is measured.

In a non-limiting aspect of the present invention, it is desirable that the image measurer measures a measured object by detecting an edge of the measured object within the combined image, and the edge detection is performed with respect to inside of a mask pattern, which is specified according to a shape of the measured object within the combined image. According to such a configuration, the image measurer detects the edge by using a mask pattern specified according to a shape of the measured object within the combined image. Therefore, the edge of the measured object can be adequately detected.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a block diagram illustrating a schematic configuration of an image measuring apparatus according to an embodiment of the present invention;

FIG. 2 is a flow chart illustrating a measuring method of the image measuring apparatus according to the embodiment;

FIGS. 3(A)-3(C) illustrate states in which an image capturer is directed to capture a plurality of images according to the embodiment;

FIGS. 4(A) and 4(B) are enlarged views of a combining section in a combined image according to the embodiment;

FIGS. 5(A)-5(C) illustrate states in which an image measurer is measuring a measured object according to the embodiment; and

FIGS. 6(A)-6(C) illustrate examples of measuring a circle larger than a field of view of an image capturer.

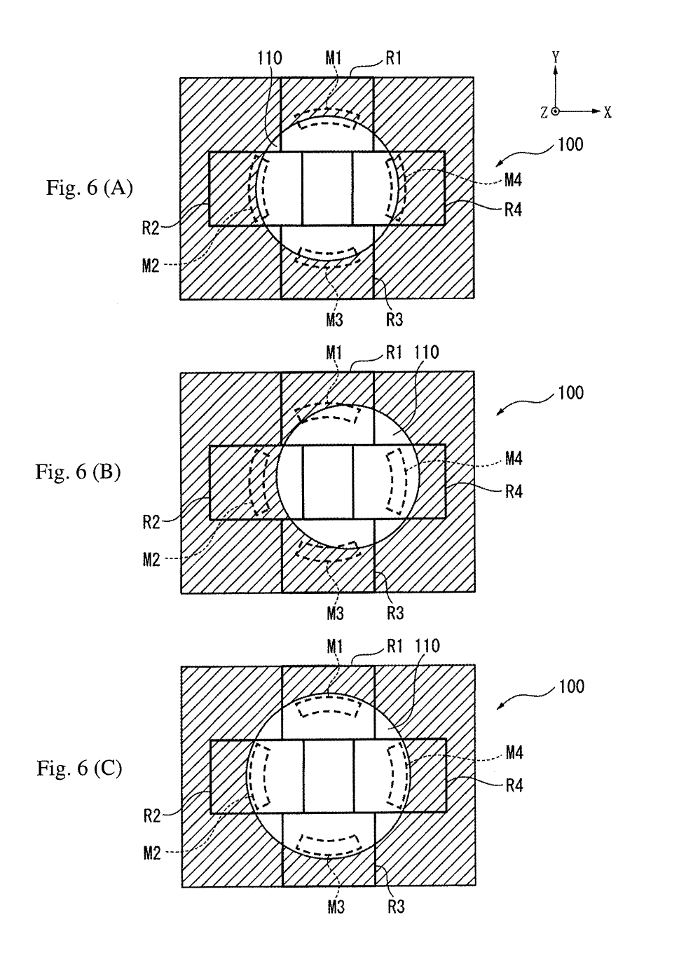

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

In the following, an embodiment of the present invention is explained based on the drawings.

### Image Measuring Apparatus Schematic Configuration

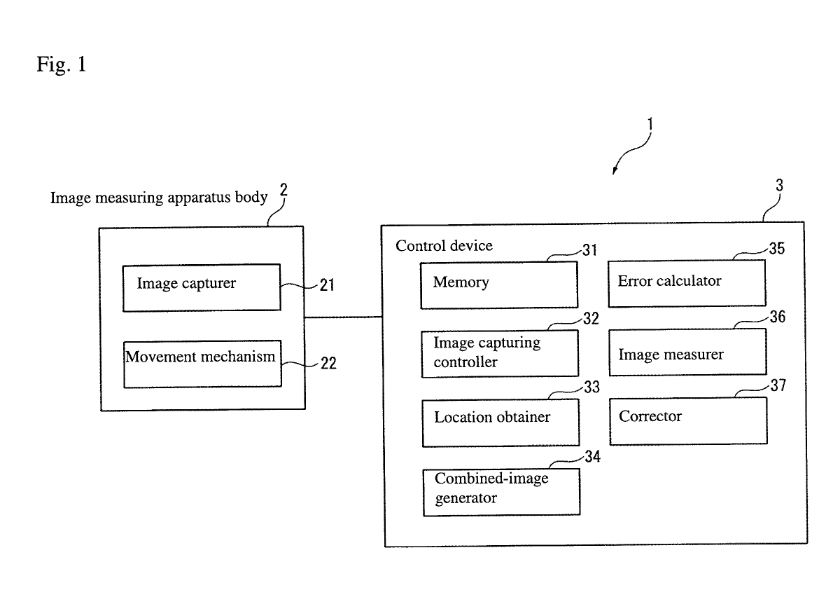

FIG. 1 is a block diagram illustrating a schematic configuration of an image measuring apparatus 1 according to an embodiment of the present invention. As illustrated in FIG. 1, the image measuring apparatus 1 includes an image measuring apparatus body 2 and a control device 3 controlling the image measuring apparatus body 2. The image measuring apparatus body 2 includes an image capturer 21, which is constituted with a CCD camera and the like, capturing an image of a measured object (not shown in the figure), and a movement mechanism 22 causing a relative movement between the measured object and the image capturer 21. The movement mechanism 22 may be any mechanism that can cause a relative movement between the measured object and the image capturer 21. For example, it can be constituted with a table, which has the measured object mounted thereon and can move along a first axis direction, and a mechanism, which can move the image capturer 21 along a second axis direction, the second axis being perpendicular to the first axis.

As a controller, the control device 3 can be configured to include a CPU (Central Processing Unit), a memory, and the like, to control the image capturer 21 and the movement mechanism (or mover) 22. This control device 3 includes a memory 31, an image capturing controller 32, a location obtainer 33, a combined-image generator 34, an error calculator 35, an image measurer 36, and a corrector 37, and measures a measured object based on an image captured by the image capturer 21.

The memory 31 stores information used when measuring a measured object. The image capturing controller 32 directs the movement mechanism 22 to cause a relative movement between the measured object and the image capturer 21, and directs the image capturer 21 to capture a plurality of images. The location obtainer 33 acquires a location at which the image capturer 21 captures an image of the measured object. The location obtainer 33 acquires the location based on an amount of the relative movement caused by the movement mechanism 22 between the measured object and the image capturer 21.

The combined-image generator 34 forms a combined image by superposing each of the images captured by the image capturing controller 32 to combine the images. The error calculator 35 calculates, for each of combining sections, an error that occurs at a combining section when the combined image is formed, based on the location acquired by the location obtainer 33. The image measurer 36 measures the measured object, based on the number of pixels in the combined image. The corrector 37 corrects measurement results of the image measurer 36, based on the error for each of the combining sections calculated by the error calculator 35.

### Image Measuring Apparatus Measuring Method

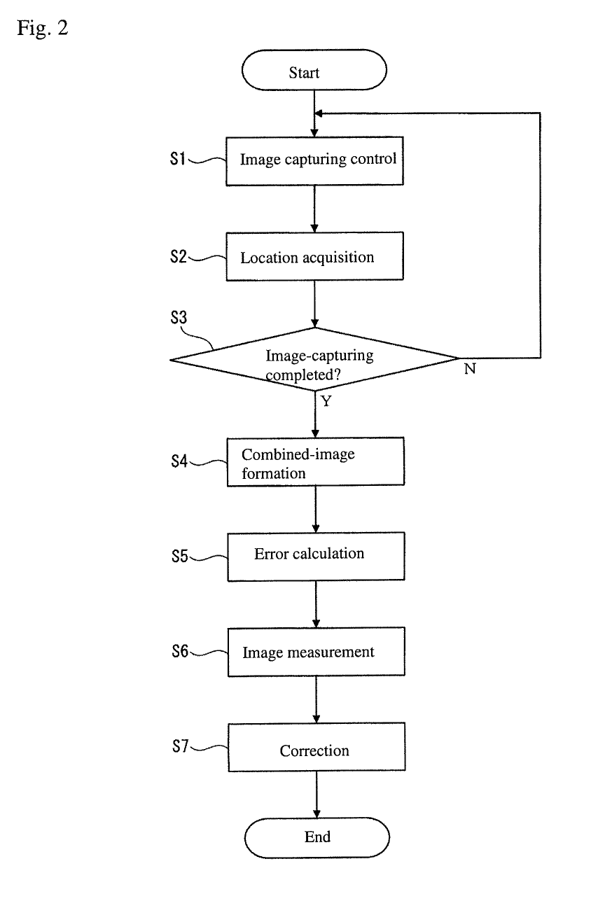

FIG. 2 is a flow chart illustrating a measuring method of the image measuring apparatus 1. As FIG. 2 illustrates, after a measurement of a measured object is started, the image measuring apparatus 1 executes the following steps S1-S7. After a measurement of a measured object is started by the image measuring apparatus 1, the image capturing controller 32 directs the movement mechanism 22 to cause a relative movement between the measured object and the image capturer 21, and directs the image capturer 21 to capture a plurality of images (S1: image capturing control step).

After an image of the measured object is captured at the image capturing control step S1, the location obtainer 33 acquires a location at which the image capturer 21 captures the image of the measured object (S2: location acquisition step). After the location at which the image of the measured object is captured is acquired, the control device 3 determines whether all images in a range specified by a user of the image measuring apparatus 1 are captured (S3: image-capturing completion determination step).

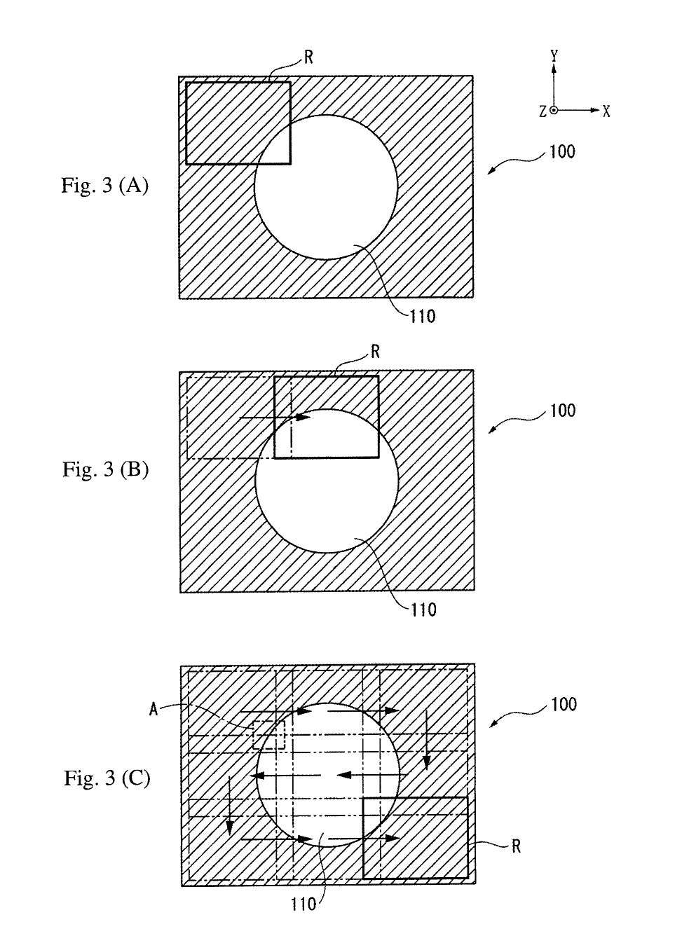

FIGS. 3(A)-3(C) illustrate states in which the image capturer 21 is directed to capture a plurality of images. FIGS. 3(A)-3(C) also illustrate examples of measuring a pattern 100, which includes a circle 110 as a measured object larger than a field-of-view R of the image capturer 21. In FIGS. 3(A)-3(C), an axis perpendicular to plane of paper is chosen as Z-axis, and two axes perpendicular to the Z-axis are chosen as X-axis and Y-axis. Specifically, as illustrated in FIG. 3(A), the image capturing controller 32 directs the movement mechanism 22 to cause a relative movement between the pattern 100 and the image capturer 21 to move the field-of-view R of the image capturer 21 to upper left of the pattern 100. Then, the image capturing controller 32 directs the image capturer 21 to capture an image of the pattern 100. And, the location obtainer 33 acquires a location at which the image capturer 21 captures the image of the pattern 100. The image captured by the image capturing controller 32 and the location acquired by the location obtainer 33 are stored in the memory 31.

Next, as illustrated in FIG. 3(B), the image capturing controller 32 directs the movement mechanism 22 to cause a relative movement between the pattern 100 and the image capturer 21 to move the field-of-view R of the image capturer 21 toward the +X-axis direction (rightward in FIGS. 3(A)-3(C)) to superpose the already-captured image of the pattern 100 (dashed-two dotted line in FIG. 3(B)). Then, the image capturing controller 32 directs the image capturer 21 to capture an image of the pattern 100. And, the location obtainer 33 acquires a location at which the image capturer 21 captures the image of the pattern 100. Further, as illustrated in FIG. 3(C), the image capturing controller 32 directs the movement mechanism 22 to cause relative movements between the pattern 100 and the image capturer 21 and directs the image capturer 21 to capture all images in the range specified by the user of the image measuring apparatus 1.

After it is determined that all images are captured at the image-capturing completion determination step S3, the combined-image generator 34 forms a combined image by superposing each of the images captured by the image capturing controller 32 to combine the images (S4: combined-image formation step). Here, when forming a combined image by superposing each of the images to combine the images, due to a quantization error and the like of the image capturer, it is possible for an error of less than one pixel to occur at a combining section in the combined image. In the embodiment, when combining each of the images, the combined-image generator 34 combines the images in a manner that the combined image is spread out along a combining direction.

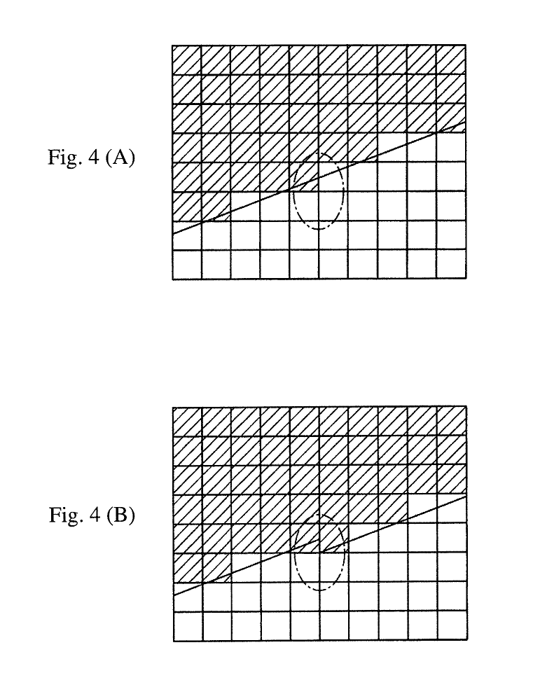

FIGS. 4(A) and 4(B) are enlarged views of a combining section in a combined image. Specifically, FIGS. 4(A) and 4(B) are enlarged views of an area A enclosed by a dashed-dotted line in FIG. 3(C), in which each pixel is illustrated as a square. Specifically, when combining each of the images, the combined-image generator 34 combines the images in a manner that the combined image is spread out along a combining direction. Therefore, as illustrated in FIGS. 4(A) and 4(B), when the combined-image generator 34 combines each of the images, a misalignment of one pixel occurs at a combining section in the combined image (dashed-dotted line in FIGS. 4(A) and 4(B)), in a case where no error occurs (see FIG. 4(A)) and in a case where an error occurs (see FIG. 4(B)).

After a combined image is formed at the combined-image formation step S4, based on the location acquired by the location obtainer 33, the error calculator 35 calculates, for each of combining sections, an error that occurs at a combining section when the combined image is formed (S5: error calculation step). For example, in FIG. 3(B), when forming a combined image of an already-captured image of the pattern 100 (dashed-two dotted line in FIG. 3(B)) and a newly-captured image of the pattern 100, that is, the image of the pattern 100 contained in the field-of-view R of the image capturer 21, to calculate an error that occurs at a combining section, the following procedures are followed. In the following explanation, the already-captured image of the pattern 100 is denoted as an image Im1, and the newly-captured image of the pattern 100 is denoted as an image Im2.

A location at which the image capturer 21 captures the image Im1 is denoted as (X₁, Y₁), and a location at which the image capturer 21 captures the image Im2 is denoted as (X₂, Y₂). Then, a relative movement amount (dX, dY) between the pattern 100 and the image capturer 21 is expressed by the following equations (1) and (2). In the present embodiment, the pattern 100 and the image capturer 21 do not move along the Y-axis direction. Therefore, dY=0.

dX=X₂−X₁ (1)

dY=Y₂−Y₁ (2)

Here, a distance along the X-axis direction corresponding to one pixel in an image captured by the image capturer 21 is denoted as psX, and a distance along the Y-axis direction is denoted as psY. An error along the X-axis direction that occurs at a combining section when a combined image is formed is denoted as erX, and an error along the Y-axis direction is denoted as erY. Then, relationship of these quantities with the relative movement amount (dX, dY) between the pattern 100 and the image capturer 21 is expressed by the following equations (3) and (4).

dX=a1×psX+erX (3)

dY=a2×psY+erY (4)

Here, a1 and a2 are integers, and are determined from the following two requirements. One requirement is that, when combining each of the images, the combined-image generator 34 combines the images in a manner that the combined image is spread out along a combining direction. The other requirement is that, as expressed by the following equations (5) and (6), the error that occurs at a combining section is less than the distance (psX, psY) corresponding to one pixel in an image captured by the image capturer 21.

0≦erX<psX (5)

0≦erY<psY (6)

Therefore, based on the following equations (7) and (8), the error calculator 35 calculates the error (erX, erY) that occurs at a combining section when a combined image is formed. And, the error calculator 35 stores the error (erX, erY) for each of combining sections in the memory 31.

erX=dX−a1×psX (7)

erY=dY−a2×psY (b 8)

After the error (erX, erY) that occurs at a combining section is calculated for each of combining sections at the error calculation step S5, the image measurer 36 measures the circle 110 based on the number of pixels in a combined image (S6: image measurement step).

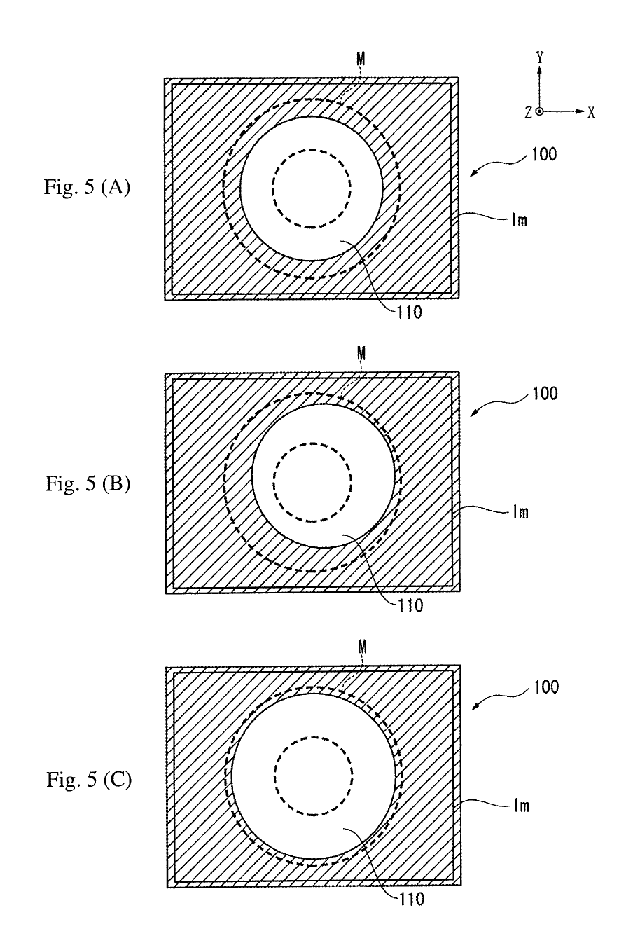

FIGS. 5(A)-5(C) illustrate states in which the image measurer 36 is measuring the circle 110. In FIGS. 5(A)-5(C), a combined image Im that is formed by the combined-image generator 34 is indicated with a solid line. The image measurer 36 measures a shape, dimensions, and the like, of the circle 110 by processing the combined image Im that is formed by the combined-image generator 34. Specifically, the image measurer 36 measures the circle 110 by detecting an edge of the circle 110 within the combined image Im. The edge detection, as illustrated in FIG. 5(A), is performed with respect to inside of a ring-shaped mask pattern M, which is specified according to the shape of the circle 110 within the combined image Im.

Therefore, even when a location of the circle 110 is out of alignment with a predetermined location (see FIG. 5(B)), or when a dimension of the circle 110 is larger than a predetermined dimension (see FIG. 5(C)), the edge of the circle 110 can be adequately detected. And, the image measurer 36 measures a center, a diameter, and the like, of the circle 110 based on the number of pixels between edges of the circle 110 and the distance (psX, psY) corresponding to one pixel in an image captured by the image capturer 21.

After the circle 110 is measured at the image measurement step S6, the corrector 37 corrects measurement results of the image measurer 36, based on the error for each of the combining sections calculated by the error calculator 35 (S7: correction step). For example, when the image measurer 36 measures a number of pixels between edges of the circle 110, in a case where more than one combining sections exist between images for which an edge is detected (the images being among the images captured by the image capturing controller 32), the corrector 37 corrects the measurement results of the image measurer 36 based on a summation of errors of the combining sections that exist between the images for which an edge is detected.

The present embodiment, as described above, has the following effects. (1) The control device 3 includes the combined-image generator 34 forming the combined image Im by superposing each of the images captured by the image capturing controller 32 to combine the images. Therefore, it is possible to avoid a situation where, due to a quantization error and the like of the image capturer 21, a gap occurs at a combining section when a combined image is formed. (2) The control device 3 includes the error calculator 35 calculating, for each of combining sections, an error that occurs at a combining section when the combined image Im is formed, based on a location at which the image capturer 21 captures an image of the circle 110. Therefore, it is possible to calculate the error that occurs at a combining section when the combined image Im is formed, due to a quantization error and the like of the image capturer 21. And, the corrector 37 corrects measurement results of the image measurer 36, based on the error for each of the combining sections calculated by the error calculator 35. Therefore, the image measuring apparatus 1 allows the circle 110 to be adequately measured even for the case where the circle 110 larger than the field-of-view R of the image capturer 21 is measured. (3) The image measurer 36 detects an edge by using the mask pattern M specified according to a shape of the circle 110 within the combined image Im. Therefore, the edge of the circle 110 can be adequately detected.

### VARIATIONS OF THE EMBODIMENT

The present invention is not limited to the above embodiment. Variations, improvements, and the like, within the scope of achieving the purpose of the present invention are included in the present invention. For example, in the embodiment, the image measurer 36 detects an edge by using the mask pattern M specified according to a shape of the circle 110 within the combined image Im. However, it is also possible to detect an edge using a mask pattern of a different shape. It is also possible to detect an edge without using a mask pattern. Further, it is also possible for the image measurer to measure a measured object by performing image processing other than edge detection. The point is that the image measurer measures a measured object based on the number of pixels in a combined image.

In the embodiment, when combining each of images, the combined-image generator 34 combines the images in a manner that the combined image is spread out along a combining direction. However, it is also possible to combine the images in a manner that the combined image is narrowed. Further, for example, it is also possible to decide whether to combine the images in a manner that the combined image is spread out or in a manner that the combined image is narrowed according to a state of each of the images to be combined. In this case, the error calculator modifies an error calculation method according to the respective image combining method. The point is that the combined-image generator forms a combined image by superposing each of the images captured by the image capturing controller to combine the images.

In the embodiment, after the combined-image generator 34 forms the combined image Im, the error calculator 35 calculates, for each of combining sections, an error that occurs at a combining section. However, it is also possible to calculate, for each of combining sections, an error that occurs at a combining section, when an image is newly captured by the image capturing controller 32. The point is that the error calculator calculates, for each of combining sections, an error that occurs at a combining section when a combined image is formed, based on a location acquired by the location obtainer.

The present invention can be suitably used as an image measuring apparatus.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An image measuring apparatus comprising:
an image capturer configured to capture an image of a measured object, the image measuring apparatus configured to measure the measured object based on an image captured by the image capturer;
a mover configured to impart relative movement between the measured object and the image capturer; and
a controller configured to control the image capturer and the mover, the controller comprising:
an image capturing controller configured to control the mover to impart the relative movement between the measured object and the image capturer, and further configured to control the image capturer to capture a plurality of images;
a location obtainer configured to acquire a location at which the image capturer captures an image of the measured object;
a combined-image generator configured to form a combined image by superposing the images captured by the image capturing controller;
an error calculator configured to calculate, for each of combining sections of the combined image, an error that occurs at a combining section when the combined image is formed, based on the location acquired by the location obtainer;
an image measurer configured to measure the measured object based on the number of pixels in the combined image; and
a corrector configured to correct measurement results of the image measurer based on the error for each of the combining sections calculated by the error calculator.

2. The image measuring apparatus according to claim 1, wherein:
the image measurer is configured to measure the measured object by detecting an edge of the measured object within the combined image; and
the edge detection is performed with respect to inside of a mask pattern specified according to a shape of the measured object within the combined image.
